(19) United States
(12) Patent Application Publication
(10) Pub. No.: US 2003/0126747 A1
(43) Pub. Date: Jul. 10, 2003

(54) Free-standing scissors

(76) Inventor: Jun Kusaba, Tokyo (JP)

Correspondence Address: JUN KUSABA, 7-11, 1chome Jyuujyou-nakahara, Kitaku, Tokyo, JP

(21) Appl. No.: 10/173,535

(22) Filed: Jun. 10, 2002

(30) Foreign Application Priority Data
Jan. 4, 2002 (JP) 33207

(51) Int. Cl. B26B 13/00

(52) U.S. Cl. 30/253; 30/245; 30/261

(57) ABSTRACT

A somewhat broad grip has been attached by a screw at the outer edge Of each of the 2 blades that comprise the scissors. A free-standing scissor has been invented in which the grips have been given a shape that make them easy to grasp by hand, and on the grips' outer surfaces, support in sections to enable free-standing have been provided such that they are nearly perpendicular to the plane of the blades. Further, the 2 blades are attached by a shaft, and at the rear of the shaft, a spring has been attached inside the grips, assisting in the opening of the blade tips, and keeping the blades always able to cut materials such as paper. Therefore, with the invention placed on a desk or other flat surface, if the front of the top grip is pressed from above, the blade tips close, enabling cutting of materials such as paper, and when the user's hand is released, the blade tips open again, enabling use even by persons with little fingertip strength. In addition, if the invention is allowed to stand freely on a desk or other flat surface with the rear of the grip on the bottom, when used as a nigiri-basami (traditional Japanese scissors shaped like tweezers), it can be grasped immediately and directly applied to the operation of cutting materials such as paper.

### BACKGROUND OF THE INVENTION

This invention pertains to an improvement on the scissors in general use.

### SUMMARY OF THE INVENTION

This invention is a scissors designed to be able to cut materials such as paper if its grips are grasped by hand, and to be able to cut materials such as paper if the top grip is pressed from above with the invention placed on a desk or other flat surface.

### BRIEF DESCRIPTION OF THE INVENTION

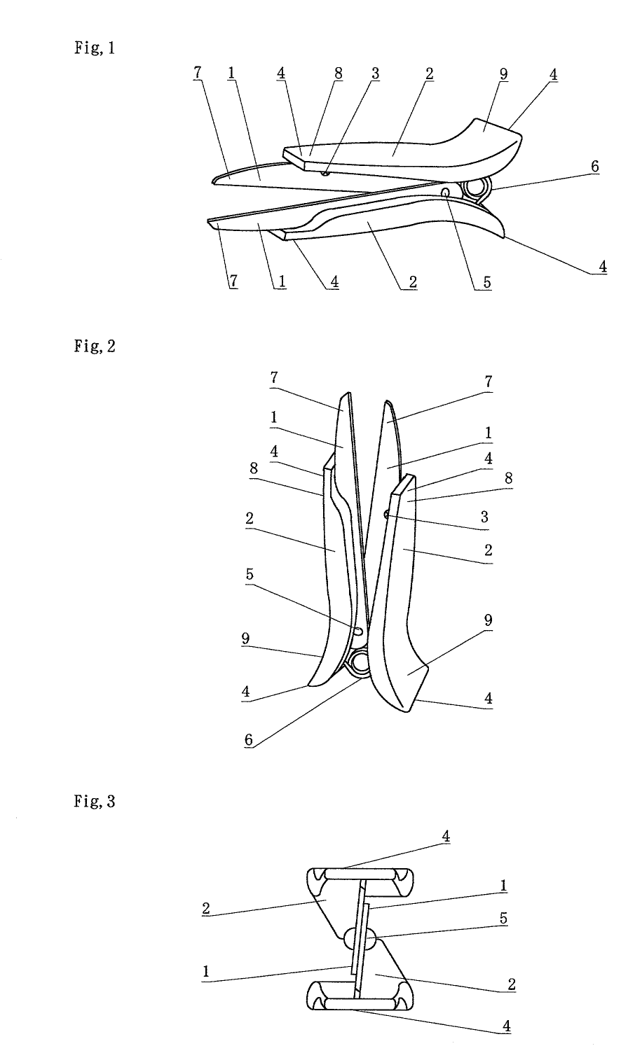

FIG. 1 Diagonal view showing example of how this invention, the free-standing scissors, stands freely.

FIG. 2 Diagonal view showing another example of how this invention stands freely.

FIG. 3 Front view of this invention seen from the blade tips.

### EXPLANATION OF NUMBERS

1. Blade

2. Grip

3. Screw

4. supporting sections to enable free-standing

5. Shaft

6. Spring

7. Blade tip

8. Grip front

9. Grip rear

### DETAILED DESCRIPTION OF THE INVENTION

A somewhat broad grip (2) has been attached by a screw (3) at the outer edge of each of the 2 blades (1) that comprise the scissors. The grips have been given a shape that makes them easy to grasp by hand, and on the grips' outer surfaces, supporting sections to enable free-standing (4) have been provided such that they are nearly perpendicular to the plane of the blades. Further, the 2 blades are attached by a shaft (5), and at the rear of the shaft, a spring (6) has been attached inside the grips, assisting in the opening of the blade tips (7), and keeping the blades always able to cut materials such as paper. Therefore, as shown in the first figure, with the invention placed on a desk or other flat surface, if the front of the top grip (8) is pressed from above, the blade tips close, enabling cutting of materials such as paper, and when the user's hand is released, the blade tips open again. However, even if no spring is incorporated with in the structure, pressing the rear of the top grip (9) opens the blade tips, and pressing the front of the top grip enables cutting of materials such as paper. Further, as shown in the second figure, if the invention is allowed to stand freely on a desk or other flat surface with the rear of the grips on the bottom, when used as a nigiri-basami (traditional Japanese scissors shaped like tweezers), it can be grasped Immediately and directly applied to the operation of cutting materials such as paper, so is very easy to use. In addition, employing the warp and elasticity of plate, the blades are structured so that their surfaces always come into contact with one another, and as shown in the third figure, with each blade attached to its grip in a plane slightly tilted from the perpendicular, when the top grip is pressed from above, the blades form a somewhat overlapping structure, enabling them to contact reliably and therefore cut reliably.

What is claimed is:

1. A somewhat broad grip (2) has been attached by a screw (3) at the outer edge of each of the 2 blades (1) that comprise the scissors. A free-standing scissors in which the grips have been given a shape that makes them easy to grasp by hand, and on the grips' outer surfaces, supporting sections to enable free-standing (4) have been provided such that they are nearly perpendicular to the plane of the blades.

2. A free-standing scissors in which the 2 blades are attached by a shaft (5), and at the rear of the shaft, a spring (6) has been attached inside the grips.

3. A free-standing scissors with each blade attached to its grip in a plane slightly tilted from the perpendicular.
